(19) United States
(12) Patent Application Publication
(10) Pub. No.: US 2014/0338121 A1
(43) Pub. Date: Nov. 20, 2014

(54) PATIENT POSITIONING DEVICE

(71) Applicant: Brandon Cuongquoc Giap, San Diego, CA (US)

(72) Inventor: Brandon Cuongquoc Giap, San Diego, CA (US)

(21) Appl. No.: 14/340,611

(22) Filed: Jul. 25, 2014

Related U.S. Application Data
(63) Continuation of application No. 13/359,734, filed on Jan. 27, 2012.
Application No. 13/359,734 is a continuation-in-part of application No. 13/153,432, filed on Jun. 5, 2011, now Pat. No. 8,661,580.
(60) Provisional application No. 61/351,769, filed on Jun. 4, 2010.

(51) Int. Cl. A61G 7/10; A61G 15/10

(52) U.S. Cl. CPC A61G 7/1023; A61G 15/10
USPC 5/81.1 T

(57) ABSTRACT

A positioning device includes a planar sheet having first and second side edges and a top surface. A patient is positioned on the top surface where the first and second side edges are adjacent to the patient's legs. A first flexible substrate and a second flexible substrate are coupled to the respective first and second side edge of the sheet and are capable of wrapping around an adjacent leg of the patient creating a wrapped engagement. This wrapped engagement of the patient's legs prevents heat loss during pre-surgery, surgery, post-surgery or transport of the patient. Handles coupled to the sheet may be utilized for lifting or moving the sheet when the patient is supported by the sheet.

### BACKGROUND OF THE INVENTION

The transfer of a patient from one support platform to another is a difficult procedure for hospital staff. In a hospital setting, patients are constantly being moved. For example, a patient entering the hospital via ambulance is moved from the medical stretcher or ambulance gurney to a hospital gurney, a fixed hospital bed, an examination table, or an operating table. Also, patients already in a hospital need to be moved as well. For instance, a patient having surgery may be moved from a fixed hospital bed to a hospital gurney then to an operating table and finally back to a fixed hospital bed. Each time a patient is moved a sliding or lateral movement of the patient from one support surface to another is required.

Difficulties for patients and hospital staff may arise from this lateral transferring of patients. Typically, the hospital staff acting in concert is responsible to position and move the patient to the new support surface by means of lifting, sliding or dragging. This action may cause injury to the patient if the patient accidently slides off of the support surface or if the patient is dropped. Also the hospital staff may be injured from the act of lifting, sliding or dragging a heavy patient.

The prior art teaches various systems designed to move patients without actually lifting. These systems employ air rollers, pull straps and inflation as a means to drag patients to and from support surfaces. Many of these systems are intended for single-patient/single-use application, such that the devices stay with the patient from the hospital bed to the operating room table.

Hypothermia is a recognized and common occurrence for patients during surgery. Patients who develop hypothermia are at a greater risk for complications, including a greater chance of heart problems, higher rates of infection, increased blood loss and prolonged recovery. To counter this, medical personnel may cover the patient with blankets. Blankets are typically bulky, frequently unravel, and may fall off the patient during pre-surgery, surgery, post-surgery or transport.

The use of surgical drapes or surgical leggings is known in the art. These are typically sterile, disposable, thin panels of fabric that are used during surgeries when the patient is in a lithotomy position involving the pelvis and lower abdomen such as during colon or genitourinary surgery. The main purpose of drapes or leggings is to isolate the surgical area and maintain a sterile environment thus helping to prevent infection. Also, some drapes or leggings control and contain fluid. These drape and leggings must be impervious to liquid strikethrough.

A design for positioning a patient is provided in “Patient Positioning Device,” U.S. patent application Ser. No. 13/153,432, filed Jun. 5, 2011, referred to as “Giap patent application,” which is hereby incorporated by reference in its entirety for all purposes.

### BRIEF SUMMARY OF THE INVENTION

A positioning device is described. This device includes a planar sheet having first and second side edges and a top surface. A patient is positioned on the top surface where the first and second side edges are adjacent to the patient's legs. A first flexible substrate and a second flexible substrate are coupled to the respective first and second side edge of the sheet and are capable of wrapping around an adjacent leg of the patient creating a wrapped engagement. This wrapped engagement of the patient's legs prevents heat loss during pre-surgery, surgery, post-surgery or transport of the patient. Handles coupled to the sheet may be utilized for lifting or moving the sheet when the patient is supported by the sheet.

The present invention is better understood upon consideration of the detailed description below in conjunction with the accompanying drawings and claims.

### BRIEF DESCRIPTION OF THE DRAWINGS

FIG. 1 is a flowchart of an embodiment of surgical events.

FIG. 2 shows an embodiment of the patient positioning device.

FIG. 3A depicts an embodiment of the patient positioning device.

FIG. 3B is an embodiment of the patient positioning device with continuous attachment points.

FIG. 3C is an embodiment of the patient positioning device with non-continuous attachment points.

FIG. 4 shows a patient in a lithotomy position.

FIG. 5 depicts an embodiment of the patent positioning device with perforated and disposable leggings.

FIG. 6 illustrates an embodiment of the patent positioning device with a patient supported thereon.

FIG. 7 illustrates an embodiment of the patient positioning device with the legging wrapped engagements.

FIG. 8 depicts an embodiment for fasteners for the patient positioning device.

FIG. 9 shows an embodiment for the patient positioning device with windows.

### DETAILED DESCRIPTION OF THE EMBODIMENTS

Described herein is a patient positioning device used to position, protect, secure and prevent heat loss of a patient while on a support surface, during transfer to another support surface, and/or during pre-surgery, surgery or post-surgery. The positioning device may be used during any surgery regardless of the position of the patient. In fact, when the patient is in a lithotomy position, one embodiment of the patient positioning device is a surgical leggings feature. These surgical leggings, also referred to as support substrates, of the present invention are used to protect the patient as well as prevent heat loss.

The following description is presented to enable a person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims. Reference now will be made in detail to embodiments of the disclosed invention, one or more examples of which are illustrated in the accompanying drawings.

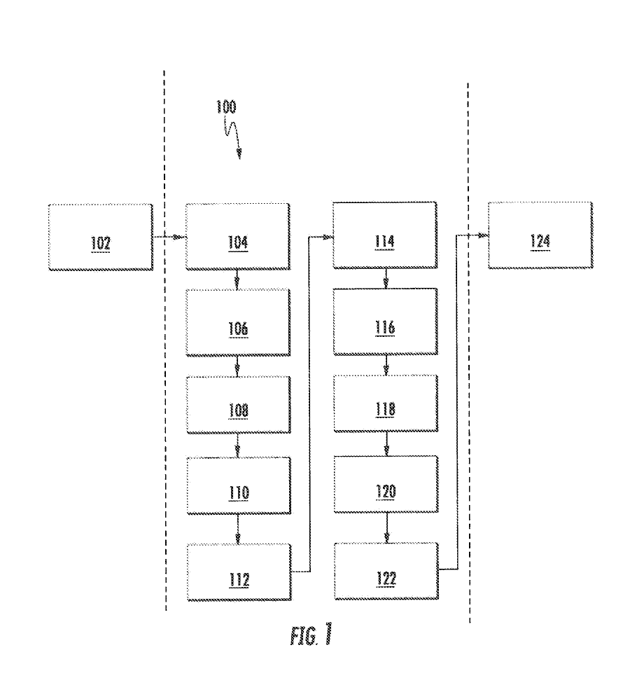

A patient experiences a multitude of stages when undergoing surgery. FIG. 1 is a flowchart of possible surgical events 100. The process starts in a pre-operative area. At waiting step 102, the patient waits here before entering the operating room for surgery. Next, the patient is transferred into the operating room and at pre-induction step 104, the pre-induction phase begins. The patient is placed on any necessary monitors such as blood pressure cuffs, Electrocardiography (EKG) electrodes, pulse oximeter, intravenous therapy (IV), or the like. At induction step 106, or induction, the patient is administered anesthesia for surgery.

At positioning step 108, the patient is positioned for surgery. Depending on the type of surgery, the patient may be positioned in a prone, supine, lithotomy or lateral decubitus position. During this time the patient's body parts are often exposed to cold, ambient air normal in an operating room. Loss of body heat is a concern during the surgical process and the patient's body may become hypothermic.

Hypothermia may occur during the surgical process. Under anesthesia there may be a loss of the behavioral response to cold and impairment of thermoregulatory heat-preserving mechanisms through the hypothalamus and autonomic nervous system. Anesthetics also cause peripheral vasodilation, causing redistribution of the blood volume with associated heat loss, leading to significant reduction of core temperature. In addition to this, patients may be exposed during their surgery, further accelerating heat loss, and may already have become cold during the inactive period waiting for surgery. With fluid deprivation, conventionally practiced for up to 6-8 hours before general anesthesia, the patient may also become relatively dry and poorly perfused so that heat distribution by their circulation is further impaired. Finally, although steps may be taken to avoid it, un-warmed anesthetic gases and intravenous infusions may also add to the reduction of core temperature.

At preparation step 110, the patient is prepared for surgery: This involves preparing the patient's skin area for surgical incision by using an antiseptic solution to help reduce infection. Further heat loss from the patient's body may occur. Next, draping the patient occurs at draping step 112. During this stage, the patient's incision area is isolated and exposed for surgery, while the remainder of the body is typically covered with sterile drapes. These sterile drapes are normally made of thin polypropylene material providing minimal heat loss prevention while the primary purpose is to provide a sterile environment to reduce infection during the surgery.

At surgery start step 114, surgery starts. Depending on the procedure, surgery may be short or last several hours. Again, additional heat loss from the patient's body may occur. At surgery end step 116, surgery ends.

Clean up starts at clean up step 118. The patient, sheets, coverings and instruments are cleaned and removed from soiling due to body fluids. At emergency step 120, the patient begins to emerge from anesthesia and may be awaken by medical personnel. The patient is then moved to a transporting gurney at transfer step 122 and transferred to a recovery room entering the post-operative area. At recovery step 124, the patient further recovers from anesthesia.

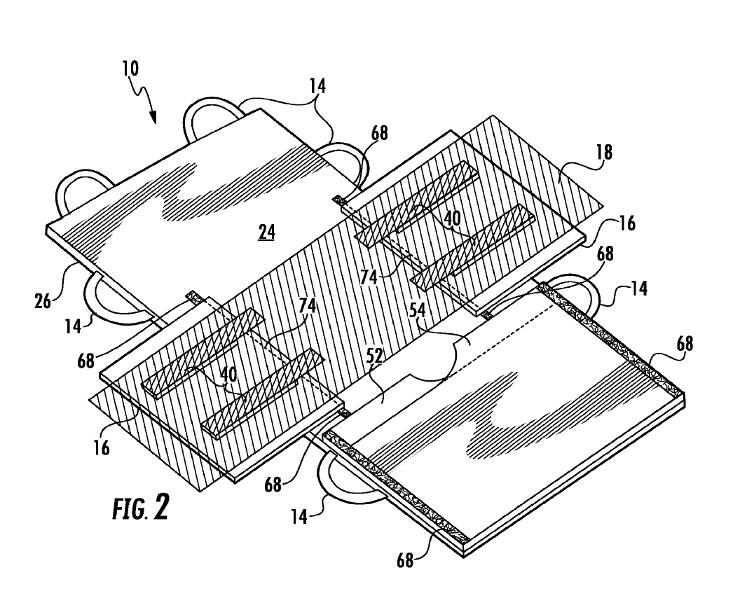

FIG. 2 depicts an embodiment of the patient positioning device 10. This device is partially described in the “Giap patent application,” which has already been incorporated by reference. A top surface 24 is positioned opposite a bottom surface 26. Top surface 24 and bottom surface 26 are formed of a flexible fabric sheet. A center section is of a rectangular geometry and adapted in length and width to accommodate the size and shape of a human being.

A plurality of handles 14 are coupled to the outer edge of the sheet which allow for a safe grip on the device when used for lifting, pulling or moving the device while the patient is being supported by top surface and secured. The quantity and orientation of handles 14 is not limited by the figure as shown but is merely simplified for illustrative purposes. Bottom surface 26 which is exposed, may be formed of any low friction material as would occur to those skilled in the art including but not limited to one or a combination of materials from a group including PTFE impregnated or coated fabric, spunbond or other fabric when woven or formed has a slippery surface, or fabrics such as rip-stop or micro fiber-based materials woven or knitted from woven nylon, or polyester. The slippery bottom surface 26 may be sewn or laminated or coated to device 10 or on the opposite side of the material forming top surface 24.

FIG. 2 also shows two disengaged padded substrates 16 which have a layer of padding imbedded or engaged such that when engaged around the arm of a patient, a means to pad the arm is provided. This protects the patient's arm from any pressure forces imparted by the table or by a surgeon. Padded substrates 16 also are configured to engage around the arms of the patient, and hold them against their body and slightly elevated from the underlying table or support surface. This helps eliminate injury to the patient's arm when it is supported on a hard table surface for a long duration by placing a gap between the table and arm.

The back surfaces of padded substrates 16 have strips of hook and loop fasteners for securing. Straps 40 have hook and loop fasteners for securing to padded substrates 16 when padded substrates 16 are wrapped around a patient's arm. In an example embodiment of the invention, an overlap system may be employed to further secure and elevate the patient's arms. The overlap system employs a flexible, rectangular overlap substrate 18 oriented lengthwise across the width of top surface 24 and attached to top surface 24. The bottom surface of overlap substrate 18 has strips of hook and loop fasteners which fasten to the hook and loop fasteners on the padded substrates 16 when engaged. Overlap substrate 18 provides a secondary means to secure the patient's arms. Furthermore, a first and second flexible substrate forming legging 52 and legging 54 are shown.

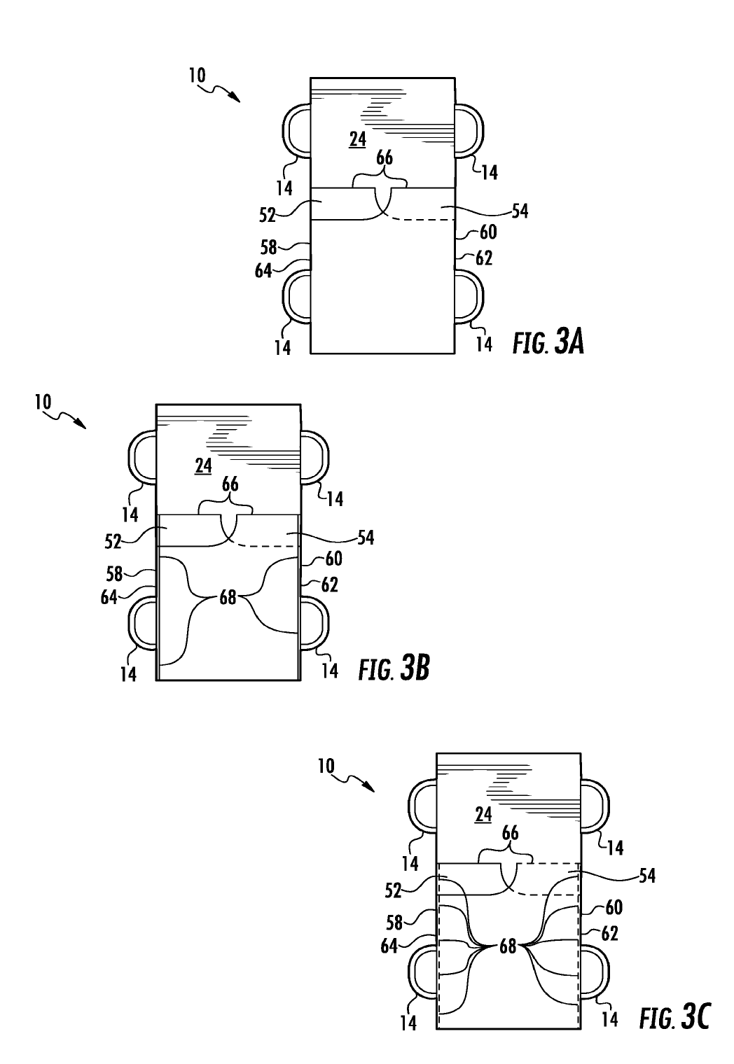

FIG. 3A depicts another embodiment of the patient positioning device. This embodiment is simpler than the embodiment of FIG. 2 and focuses on the leg support. A planar sheet has a first and second side edge and a top surface 24. This sheet is configured for positioning a patient thereon where the patient is supported by top surface 24 with the first and second side edges adjacent to the legs of the patient. A first and second flexible substrate capable of wrapping around an adjacent leg of a patient, thus creating a wrapped engagement, are detailed as legging 52 and legging 54. These wrapped engagements of the legs prevent heat loss during pre-surgery, surgery, post-surgery or transport and protect against pressure injury.

Legging 52 is mostly covered by legging 54 until it is engaged with the patient's leg. For example, more than 50%, 60%, 70%, 75%, 80%, 90% or 95% of legging 52 may be covered by legging 54. Referring to FIGS. 2 and 3A, to use the patient positioning device in one embodiment, the patient is positioned on top surface 24. Optional padded substrates 16 are configured to engage around the arms of the patient, and hold them against their body and slightly elevated from the underlying table or support surface. This helps eliminate injury to the patient's arm when it is supported on a hard table surface for a long duration by placing a gap between the table and arm. Padded substrates 16 are wrapped around a patient's arms and secured with strips of hook and loop fasteners and straps (described in more detail in “Giap patent application”).

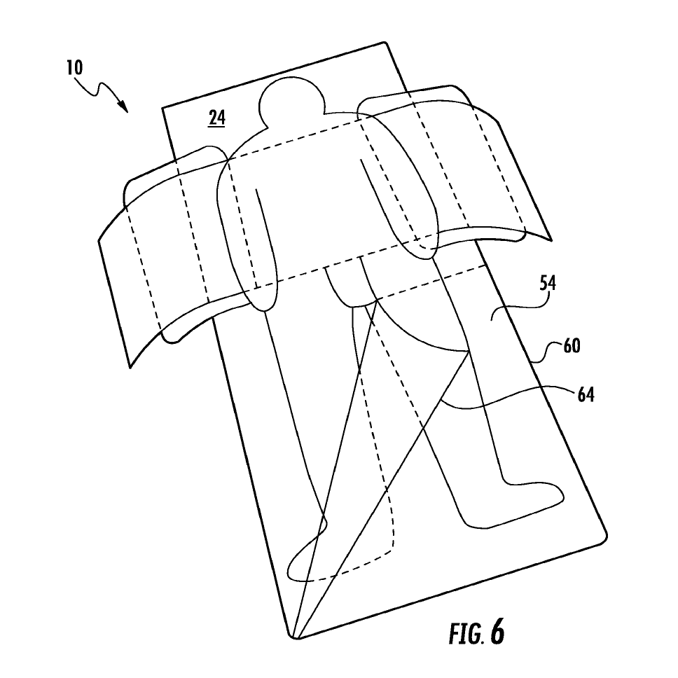

Legging 52 and legging 54 are configured to engage around the legs of the patient to protect the patient as well as prevent heat loss. Once the patient is positioned on top surface 24, the user would grasp and lift free edge 64 (see FIG. 3A) of legging 54 wrapping this flexible substrate around, e.g., over and then under, the adjacent leg, creating a wrapped engagement (see FIG. 6). Fasteners such as hooks of a hook and loop (e.g., Velcro®) may be located on the underside of legging 52 and legging 54 at respective free edges 62 and 64 (see FIG. 3A) while loops from a hook and loop fastener (e.g., Velcro®) may be located on the topside of legging 52 and legging 54 at respective attached outer edges 58 and 60 (see FIG. 3A).

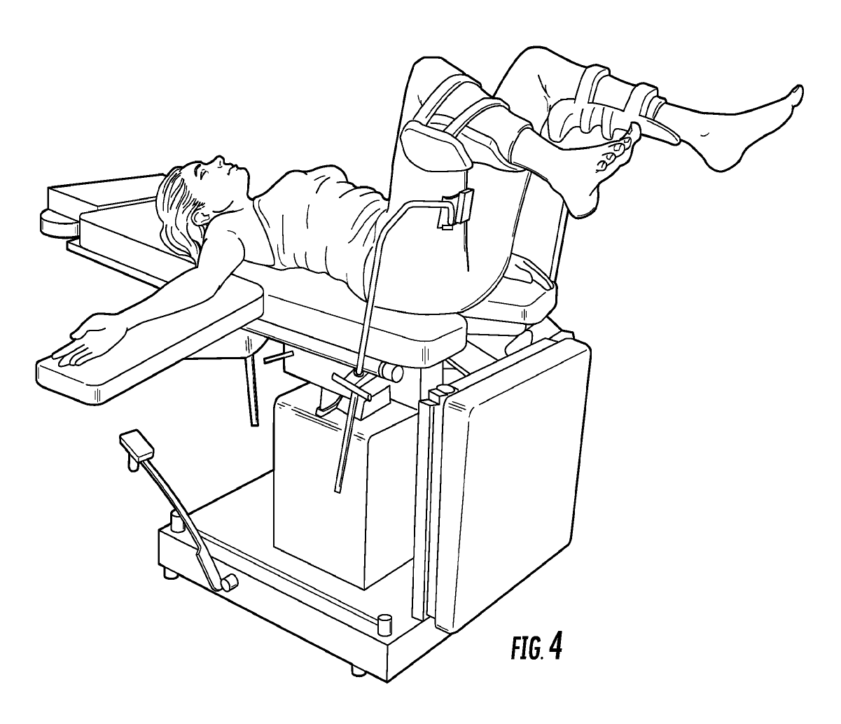

The use of these leggings is practical when the patient is in a lithotomy position (i.e. when the legs are placed in stirrups, see FIG. 4) thus involving the pelvis and lower abdomen such as during colon or genitourinary surgery. In one embodiment, legging 52 and legging 54 may be padded for protection from pressure injury that may occur due to the medical devices such as stirrups. Some studies have found a significant relationship between prolonged surgical procedures with the patient in the lithotomy position and a circulatory complication. This condition occurs when increased tissue pressure within a limited tissue space compromises the circulation and function of the contents of the space. Nerve injury to the femoral or peroneal nerve is also possible. Padding may be imbedded or engaged in the entire legging 52 and legging 54 or only in certain areas, such as in the area of contact to the knee joint, calf and/or ankle

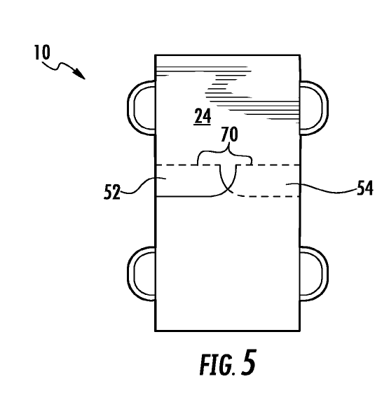

Referring to FIG. 3A, the lower portion of top surface 24 is the area of attachment for legging 52 and legging 54. These are substantially planar and integral with the sheet and attached at a top edge 66 of legging 52 and legging 54 to top surface 24. Legging 52 is also attached at an outer edge 58 of top surface 24 while legging 54 is attached at an outer edge 60 of top surface 24. These attachment areas 68 may be continuous along the entire outer edge as shown in FIG. 3B or may be non-continuous as shown in FIG. 3C. Also, the attachments may be permanently attached such as by sewing, or temporarily attached such as by hook and loop fastener (e.g. Velcro®) allowing adjustability. In one embodiment, legging 52 and legging 54 may be constructed from a material that is perforated 70 and disposable. In this way, the leggings may be easily, conveniently and completely removed from top surface 24 and thrown away. FIG. 5 illustrates this embodiment.

FIG. 6 illustrates an embodiment of the present invention with a patient supported thereon. The patient positioning device 10 is utilized to position, protect and secure a patient on a support surface for transfer to another support surface or for preparation for surgery. In different embodiments, it may function as a regular bed sheet, a surgical bed sheet, leggings or any combination. To utilize the legging feature, after the patient is positioned and secured on the sheet, legging 52 and legging 54 may be engaged. To do this, an unattached edge, or free edge 64 of legging 54 is lifted and wrapped around, i.e., over and then under, the adjacent leg, and then fastened. Legging 52 is constructed in the same manner but using free edge 62 of legging 52.

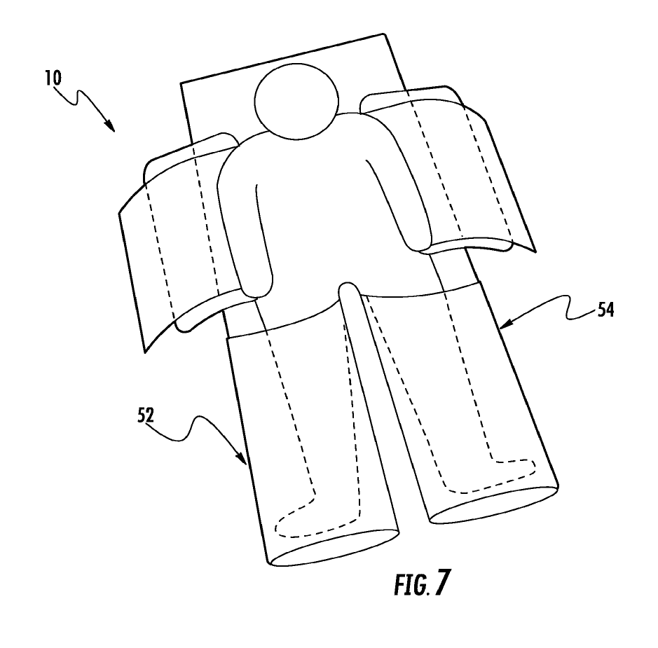

FIG. 7 illustrates another embodiment of the patient positioning device with the legging wrapped engagements. In this embodiment, legging 52 and legging 54 are loosely fitted on the legs of the patient. In this manner, any necessary medical devices such as leg compression devices, could be used when legging 52 and legging 54 are engaged.

To fasten legging 52 and legging 54, fasteners 56 such as hooks from a hook and loop fastener large or small (e.g., Velcro®) are located on the underside of legging 52 and legging 54 at respective free edges 62 and 64 while loops from a hook and loop fastener (e.g., Velcro®) are located on the topside of legging 52 and legging 54 at respective attached outer edges 58 and 60. Fasteners 56 are accessible when respective legging 52 and legging 54 are in the wrapped engagement with a respective leg.

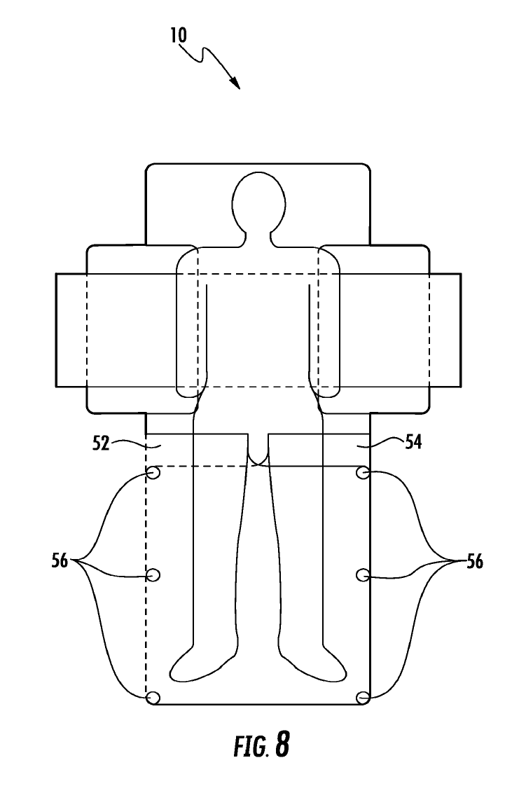

FIG. 8 depicts an embodiment for fasteners for the patient positioning device showing a plurality of fasteners. The quantity and orientation of fasteners 56 is not limited by the figure as shown but is merely simplified for illustrative purposes. In one embodiment, fasteners 56 are non-continuous. This allows access to the leg of the patient for medical equipment such as cables and tubes or for monitoring.

Forced warm-air technology is active patient warming and is associated with normalizing the patient's body temperature. This helps to maintain body temperature and prevent hypothermia. A forced air warming system is a medical electrical device used to help keep patients warm during anesthesia and surgery. The device typically comprises a reusable controller and disposable, single-use blankets. Using forced-air warming may reduce time in recovery and reduce patient shivering thus improving patient comfort and satisfaction.

The blanket used in a typical forced air-warming system is double layered and inflates in operation. The patient contact surface is permeable to air and the warm air exits the blanket and moves over the patient's skin and transfers heat to the patient by convection. The blankets are bulky and require storage space. Other methods for keeping the patient warm may be used as well.

Forced warm-air technology may be utilized with the present invention when the lower portion of the patient positioning device is configured with legging 52 and legging 54. In different embodiments, small openings, holes or channels may be placed in legging 52 and legging 54 to allow forced warm-air to penetrate through the openings and onto the patient's skin. In this manner, using forced warm-air may warm the patient or may help maintain body temperature thus preventing hypothermia. Also, a blanket may no longer be required when using the device because legging 52 and legging 54 may provide the warming function.

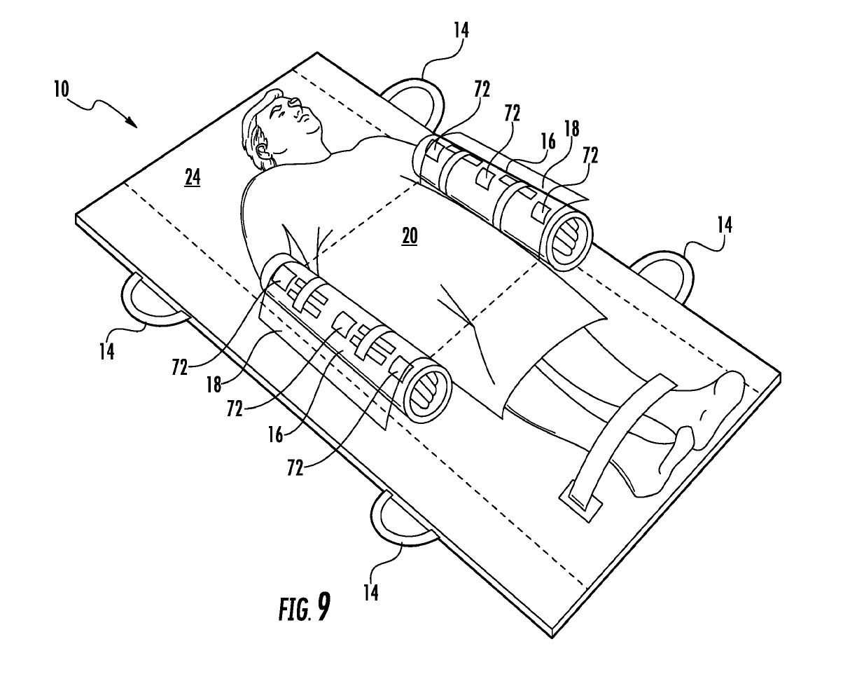

FIG. 9 shows optional windows 72 on padded substrates 16. Windows 72 in the padded substrates 16, which wrap around a patient's arms, are created for the purpose of passing through medical lines such as blood pressure cuff tubing, pulse-oximeter cables, and/or intravenous lines. These windows are also used for viewing the patient's arm without having to unwrap padded substrates 16 from the patient's arms. In one embodiment, window 72 are openings in padded substrates 16. In another embodiment, window 72 consists of a flap of material attached permanently on one side. In yet a further embodiment, window 72 consists of a flap of material temporarily attached on one or more sides such as with hook/loop Velcro®. The amount of windows may vary and the number shown in FIG. 9 is for illustration purposes.

The initial position of legging 52 and legging 54 before the wrapped engagement is flat to top surface 24 as shown in FIG. 2. Referring to FIG. 2, the position of padded substrates 16 for the patient's arms, along with legging 52 and legging 54 for the patient's legs, may be adjustable by using attachment areas 68, for example, hook/loop Velcro® placement on top surface 24. This allows the device to accommodate a wide range of different patient sizes. Also, padded substrates 16 for the patient's arms may be perforated 74. In this way, the padded substrates 16 may be easily, conveniently and completely removed from top surface 24 for disposal.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

1.-20. (canceled)

21. A patient positioning device, comprising:
a planar sheet having first and second side edges and a top surface, said planar sheet configured for positioning of said patient thereon, said patient being supported by said top surface with said first and second side edges configured to be located adjacent to legs of said patient;
a handle coupled to said planar sheet for lifting or moving said planar sheet when said patient is supported by said planar sheet;
a first flexible substrate coupled to said first side edge of said planar sheet;
a second flexible substrate coupled to said second side edge of said planar sheet;
wherein said first and second flexible substrates are configured to wrap around an adjacent leg of said patient creating respective wrapped leg engagements;
a first padded substrate and a second padded substrate each attached to said sheet, wherein said first and second padded substrates are configured to wrap around an adjacent arm of said patient creating respective wrapped arm engagements;
an overlap substrate oriented lengthwise across said planar sheet configured to wrap over and engage both of said wrapped arm engagements to hold said arms in an elevated position above said planar sheet and an underlying support surface wherein said elevated position prevents injury to said arm from said planar sheet and said underlying support surface; and
wherein said wrapped leg engagements and said wrapped arm engagements protect said patient and prevents heat loss during pre-surgery, surgery, post-surgery or transport.

22. The patient positioning device of claim 21, further comprising:
a first fastener and a second fastener on respective said first flexible substrate and second flexible substrate;
a third fastener and a fourth fastener located on a surface of a said planar sheet and accessible when said first and second flexible substrates are in said wrapped leg engagement with a respective leg;
wherein said first fastener connects to said third fastener, and said second fastener connects to said fourth fastener to secure said wrapped leg engagement of said patient.

23. The patient positioning device of claim 21, further comprising:
openings in said planar sheet at said first flexible substrate and said second flexible substrate;
wherein forced warm air is capable of penetrating through said openings to warm said patient.

24. The patient positioning device of claim 21, wherein said first flexible substrate and said second flexible substrate includes material that is perforated and disposable.

25. The patient positioning device of claim 21, wherein a bottom surface of said planar sheet has a low coefficient of friction material to aid in moving said planar sheet.

26. The patient positioning device of claim 25, wherein said low coefficient of friction material comprises PTFE impregnated fabric, PTFE coated fabric, spunbond fabric, fabric which when formed is flexible and has a slippery surface, rip-stop fabric, micro fiber-based materials woven nylon, micro fiber-based materials woven from polyester, or combinations thereof.

27. A method for positioning a patient, comprising:
providing a positioning device on an underlying support surface, said positioning device comprising a planar sheet having first and second side edges and a top surface, a first flexible substrate coupled to said first side edge of said planar sheet, a second flexible substrate coupled to said second side edge of said planar sheet, and a first padded substrate and a second padded substrate each attached to said sheet;
placing said patient on said top surface of said planar sheet with said first and second side edges adjacent to legs of said patient;
wrapping each of said first and second flexible substrates around an adjacent said leg of said patient creating respective wrapped leg engagements;
wrapping each of said first and second padded substrates around an adjacent arm of said patient creating respective wrapped arm engagements;
wherein said wrapped leg engagements and said wrapped arm engagements protect said patient and prevents heat loss during pre-surgery, surgery, post-surgery or transport.

28. The method of claim 27, further comprising the step of wrapping an overlap substrate oriented lengthwise across said planar sheet over said wrapped arm engagements to hold said arms in an elevated position above said planar sheet and said underlying support surface wherein said elevated position prevents injury to said arm from said planar sheet and said underlying support surface.

29. The method of claim 27, wherein said first flexible substrate and said second flexible substrate includes material that is perforated and disposable.

30. The method of claim 27, wherein a bottom surface of said planar sheet has a low coefficient of friction material to aid in moving said planar sheet.

31. The method of claim 20, wherein said low coefficient of friction material comprises PTFE impregnated fabric, PTFE coated fabric, spunbond fabric, fabric which when formed is flexible and has a slippery surface, rip-stop fabric, micro fiber-based materials woven nylon, micro fiber-based materials woven from polyester, or combinations thereof.
